(19) United States
(12) Patent Application Publication
(10) Pub. No.: US 2026/0264067 A1
(43) Pub. Date: Sep. 10, 2026

(54) ZEOLITE-Y AND CATALYST COMPRISING ZEOLITE-Y

(71) Applicant: ZEOPORE TECHNOLOGIES NV, Leuven (BE)

(72) Inventors: Danny VERBOEKEND, Leuven (BE); Martin Antoine D'HALLUIN, Leuven (BE)

(73) Assignee: ZEOPORE TECHNOLOGIES NV, Leuven (BE)

(21) Appl. No.: 19/162,681

(22) PCT Filed: Mar. 15, 2024
(86) PCT No.: PCT/EP2024/057007

§ 371 Date: Sep. 5, 2025

(30) Foreign Application Priority Data
Mar. 17, 2023 (NL) 2034368

(51) Int. Cl. B01J 29/16; B01J 23/888; B01J 35/61; B01J 35/63; B01J 35/69; B01J 37/06; B01J 37/08; C01B 39/02; C01B 39/24; C10G 47/20

(52) U.S. Cl. CPC B01J 29/166; B01J 23/888; B01J 35/617; B01J 35/633; B01J 35/635; B01J 35/69; B01J 37/06; B01J 37/08; C01B 39/026; C01B 39/24; C10G 47/20; C01P 2002/77; C01P 2002/82; C01P 2006/12; C01P 2006/14

(57) ABSTRACT

The invention is directed to a Zeolite-Y having a SiO2/Al2O3 ratio of greater than 10 mol/mol, a unit cell size smaller than 24.45 Å, a micropore volume greater than 0.18 ml/g, a mesopore volume greater than 0.35 ml/g, a total surface area greater than 700 m²/g and a selectivity number greater than 0.50. The selectivity number is presented as [(B350+L350)/(L150+B150)]. B350 is the Bronsted acidity of the zeolite-Y as measured by Fourier Transformed Infrared spectroscopy after pyridine desorption at 350° C. L350 is the Lewis acidity of the zeolite-Y as measured by Fourier Transformed Infrared spectroscopy after pyridine desorption at 350° C. B150 is the Bronsted acidity of the zeolite-Y as measured by Fourier Transformed Infrared spectroscopy after pyridine desorption at 150° C. L150 is the Lewis acidity of the zeolite-Y as measured by Fourier Transformed Infrared spectroscopy after pyridine desorption at 150° C. and wherein the B350, L350, B150 and L150 are measured as described in ‘Section A’.

The invention is directed to a mesoporous USY Zeolite and its application as part of a hydrocracking catalyst.

US20110108459 describes a mesoporization of an USY zeolite with molar SiO₂/Al₂O₃ ratio (SAR) of 12.4 and crystal lattice parameter (unit cell size) of 24.38 to 24.34 Å (Angstrom) using a sodium hydroxide aqueous solution, in the absence of protective agents. Relative to the starting (or ‘parent’) USY the mesoporization results in a lowering of the SAR and an increase of so-called Bronsted acidity. The selectivity to middle distillates in a hydrocracking experiment of the catalyst containing the mesoporous USY was higher as compared to when a catalyst is used containing the parent USY. The activity of the catalyst containing the mesoporous USY was slightly higher than the activity of the catalyst containing the starting parent USY in the hydrocracking reaction. The Bronsted acidity is measured by pyridine desorption at 150° C. When a similar base treatment was applied to a parent USY with SAR 50.8, the acidity reduced and the activity and selectivity in hydrocracking were not both improved.

US20210171356 describes a mesoporization of a starting USY zeolite having a unit cell ranging from 24.38 Å to 24.30 Å and a SAR of 12 by a combination of base in the absence of protective agents and acid treatment. In this work, USY with higher SARs were only exposed to a base-treatment, and not to a subsequent acid treatment.

U.S. Pat. No. 11,325,835 describes a mesoporization of a starting Y zeolite having a unit cell ranging from 24.50 Å to 24.70 Å and a SAR of 5.2 and also the mesoporization of a USY with unit cell size around 24.38 Å to 24.30 Å with SAR of 12 by means of a sequence of base-acid treatment, where the base treatment is executed in the absence of protective agents. Yet, such treatment was not applied to any Y or USY zeolite with a SAR larger than 12. A problem with the mesoporous USY zeolite as obtained by this process is that they do not yield the desired combination of selectivity and activity benefits in hydrocracking.

Verboekend et al. Chem. Mater. 2013, 25, 9, 1947-1959 describes in FIG. 12 that a mesoporization involving a base followed by an acid treatment is beneficial for a Zeolite Y having a silica to alumina ratio of between 5 and 10. For USY having a silica to alumina ratio of between 20 and 200 a desilication using a base treatment using pore-directing agents is described, and no subsequent acid treatment. The pore directing agents serve to protect the fragile USY zeolite during the base treatment, and help avoid unwanted amorphization and lowered acidities, and are herein referred to as protective agents.

A disadvantage of the hydrocracking catalysts described in US2011108459 and US2021171356 and of a hydrocracking catalyst which would comprise the modified Zeolite Y of U.S. Pat. No. 11,325,835 is that the selectivity to middle distillates, and especially the selectivity to gas oil, is not high.

Petroleum Chemistry, 2020, Vol. 60, No. 4, pp. 479-489 shows that the selectivity to iso-C16 is improved when a mesoporous USY having a silica to alumina ratio of between 26 and 56.8 is used as part of a platinum-hydrocracking catalyst in a hydrocracking experiment. The selectivity to iso-C16 is a measure of the selectivity to middle distillates. This article also shows that the mesoporization of a starting Zeolite-Y results in a lower acidity. The lower acidity is related to a lowered activity of the catalyst.

US20130292301 describes a mesoporization of a starting USY with SAR of about 60 by leaching with a sodium hydroxide aqueous solution. Relative to the parent USY Zeolite the mesoporization results in a decrease of the acid site density. The selectivity to middle distillates in a hydrocracking experiment of the catalyst containing the mesoporous USY was higher as compared to when a catalyst is used containing the starting USY. The activity of the catalyst containing the mesoporous Zeolite-Y was much lower than the activity of the catalyst containing the starting Zeolite-Y in the hydrocracking reaction.

WO2021185721 describes a mesoporization of a starting USY zeolite using cetyltrimethylammonium chloride (CTAC). When the modified USY zeolite is used as part of a hydrocracking catalyst an improvement is reported for middle distillate selectivity at a reduced catalytic activity. WO2021185721 further describes that the use of cetyltrimethylammonium chloride (CTAC) as protective agent could result in safety issues in the subsequent calcination step. According to this publication this safety issue, namely risk of explosion during calcination, is mitigated by performing the calcination on a shaped catalyst carrier comprising of the modified zeolite-Y and a binder.

US20230051097 discloses the application of a base treatment using inorganic additives to a USY with SAR of 30. In this work, a subsequent acid treatment is described aimed at the removal of the metals and/or unwanted counter cations, both deposited during the alkaline treatment. The work is silent on the impact of such treatments on the acidity of a high SAR USY. The mesoporous USY zeolites obtained using the inorganic additives by the teachings of US20230051097 differ substantially from those obtained using organic additives. A problem with the mesoporous USY zeolite as obtained by this process is that they do not yield the desired combination of selectivity and activity benefits in hydrocracking.

Within the mesoporization of faujasites with SAR>15, the acidity of the obtained mesoporous zeolites is highly relevant as it can dominate catalytic performance. Besides the total amount of acid sites, often related to the amount of aluminum in the zeolite, and the type of acid sites, typically featuring Brønsted and Lewis sites, the acid strength is influential. The assessment of zeolite's acidity can be done using typically-basic probe molecules, such as ammonia, pyridine, and CO. Particularly, spectroscopic techniques using pyridine as probe molecule are valuable enabling to measure the quantity, type, and acid strength of zeolites. See also Catalysis Reviews: Science and Engineering, 2013, 55:4, 454-515.

The nature of the acid strength of mesoporous faujasites has been studied on various occasions. In Microporous and Mesoporous Materials 194 (2014) 126-134 it was established that, whereas no significant changes occurred in total acidity, once a parent high SAR faujasite (molar SAR=62) was made mesoporous via an alkaline treatment in the presence of tetraalkylammonium cations, the acid strength reduced. Similarly, in ACS Catalysis, 2015, 5, 2, 734-743 it was demonstrated that the acid strength of a mesoporous faujasite with SAR of 22, prepared via alkaline treatments in the presence of tetraalkylammonium cations, significantly decreased with respect to its untreated parent USY zeolite. Evidently, the mesoporization of USY faujasites with SAR>15 leads to the reduction of the acid strength.

The object is to provide a zeolite-Y which, when used as part of a hydrocracking catalyst, results in a more selective and more active hydrocracking catalyst.

This is achieved by the following Zeolite-Y, featuring, in addition to ample mesopore volume, a preserved or enhanced acid strength. Zeolite-Y having a SiO₂/Al₂O₃ ratio of greater than 10 mol/mol as measured using X-ray fluorescence, a unit cell size smaller than 24.45 Å as measured by X-ray diffraction as described by the method of ASTM D3942-19, a micropore volume greater than 0.18 ml/g as described by the method of ASTM D4365-19, a mesopore volume greater than 0.35 ml/g as obtained by subtracting the micropore volume from the pore volume as obtained by the method of ASTM D4365-19, a total surface area greater than 600 m²/g as measured by the BET adsorption method of ASTM D4365-19 and a selectivity number greater than 0.50, wherein the selectivity number is presented as [(B350+L350)/(L150+B150)], wherein B350 is the Bronsted acidity of the zeolite-Y as measured Fourier Transformed Infrared spectroscopy after pyridine desorption at 350° C., L350 is the Lewis acidity of the zeolite-Y as measured by Fourier Transformed Infrared spectroscopy after pyridine desorption at 350° C., B150 is the Bronsted acidity of the zeolite-Y as measured by Fourier Transformed Infrared spectroscopy after pyridine desorption at 150° C., and L150 is the Lewis acidity of the zeolite-Y as measured by Fourier Transformed Infrared spectroscopy after pyridine desorption at 150° C. and wherein the B350, L350, B150 and L150 are measured as described in ‘Section A’.

Applicants found that when a zeolite-Y according to this invention is used as part of a hydrocracking catalyst composition in a hydrocracking process a higher selectivity to middle distillates is observed in combination with a higher activity when compared to a state of the art hydrocracking catalyst based on a zeolite Y and even when compared to a state of the art hydrocracking catalyst based on a mesoporous zeolite-Y. Moreover, these advantages are achieved while preserving or enhancing the known benefits of mesoporous faujasites as part of a hydrocracking catalyst and process, such as a reduced hydrogen consumption, better hydrogen efficiency, higher hydrogenation rate, higher plant capacity, higher stability and longer cycle time, reduced fouling and coking, ability to deal with more difficult, hence cheaper, feedstocks, higher quality of result products (higher viscosity index, lower polycyclic aromatics, and higher H-content), and increased residue conversion.

In this description the term mesoporization, mesoporization treatment or mesoporization process refers to a treatment or process wherein the volume of the mesopores of a zeolite-Y is increased relative to the volume of the mesopores of a starting parent zeolite-Y. The volume of the mesopores of a zeolite-Y is referred to as the mesopore volume (Vₘₑₛₒ) of zeolite Y.

The zeolite-Y is a zeolite having a faujasite (FAU) structure or framework topology. The zeolite is also referred to as an ultra-stable zeolite-Y or USY because of its increased hydrothermal stability, in turn due to its reduced unit cell size.

The novel zeolite-Y has a SiO₂/Al₂O₃ (SAR) ratio of greater than 10 mol/mol, preferably greater than 20 mol/mol, more preferably greater than 30 mol/mol, and most preferably of greater than 50 mol/mol. The upper range is preferably lower than 200 mol/mol, and more preferred lower than 100 mol/mol. The desired SiO₂/Al₂O₃ (SAR) ratio is preferably obtained by subjecting a parent zeolite-Y having a suitable SiO₂/Al₂O₃ (SAR) ratio to a mesoporization treatment. The SAR is measured using X-ray fluorescence (XRF). SAR stands for the molar ratio of silica to alumina expressed in mol/mol.

The unit cell size of the novel zeolite-Y is smaller than 24.45 Å and preferably between 24.22 Å and 24.32 Å. The unit cell size is measured by X-ray diffraction as described by the method of ASTM D3942-19. The desired unit cell size is preferably obtained by subjecting a parent zeolite-Y having the desired unit cell size to a mesoporization treatment.

The novel zeolite-Y may have a pore volume of between 0.55 and 1.20 and preferably between 0.70 and 0.90 ml/g. The pore volume (Vₚₒᵣₑ) is measured by nitrogen physisorption at 77 K taking the volume adsorbed at relative pressure of 0.99. The desired pore volume is preferably obtained by subjecting a parent zeolite-Y having a pore volume of between 0.40 and 0.60 ml/g, to a mesoporization treatment yielding an increase in pore volume of between 0.15 and 0.80 ml/g.

The micropore volume (V_{micro}) relates to the porosity of the zeolite Y in the size range from zero to ca. 2 nm, and is derived by application of the t-plot to the adsorption branch of the nitrogen physisorption isotherm obtained at 77K in a range of partial pressure P/PO comprised between 0.075 and 0.30 as described by the method of ASTM D4365-19. The micropore volume of the zeolite Y is above 0.15 ml/g and preferably above 0.18 ml/g, and most preferably above 0.20 ml/g. The V_{micro} of the novel zeolite Y does not exceed 0.40 ml/g, and is typically below 0.35 ml/g.

The mesopore volume (Vₘₑₛₒ) of the novel zeolite Y is the volume of pores having a diameter in the range of 2 to about 50 nm. The mesopore volume (Vₘₑₛₒ) of the novel zeolite Y is obtained by subtracting the micropore volume from the pore volume (hence Vₘₑₛₒ=Vₚₒᵣₑ−V_{micro}), both obtained by nitrogen physisorption at 77 K as described above. The mesopore volume of the zeolite Y is above 0.35 ml/g, preferably between 0.35 and 0.80 ml/g, and most preferably between 0.45 and 0.60 ml/g.

The total surface area (SBET) of the novel zeolite Y is greater than 600 m²/g, is preferably greater than 700 m²/g and may range up to 1200 m²/g and preferably between 800 and 1000 m²/g. The total surface area is measured by the BET adsorption method of ASTM D4365-19 in a range of partial pressure P/PO comprised between 0.05 and 0.30.

### Section A

Herein, the Lewis and Brønsted acidity of zeolitic materials is measured by Fourier Transformed Infrared spectroscopy (FTIR) after adsorption to saturation and partial desorption of pyridine. The area of the characteristic band of pyridine coordinated at 1455 cm⁻¹ correlates to the amount of Lewis acidity of a zeolite powder or catalyst extrudate expressed as μmol Lewis adsorbed pyridine per grams of zeolite Y. Similarly, the area of the characteristic band of pyridine protonated at 1545 cm⁻¹ correlates to the amount of Bronsted acidity of a zeolite powder or catalyst extrudate expressed as μmol Bronsted adsorbed pyridine per grams of zeolite Y. The procedure and calculation used to derive the amount of Lewis and Bronsted acidity based on the FTIR measurements are well known to the skilled person and are for example described in J. Catal., 1993, 141, 347-354 or Journal of Catalysis 385 (2020) 52-60.

Changes in desorption temperature enable to vary the degree of desorption and hereby monitor the relative strength of the probed acid sites. For example, at relatively low temperature, such as 150° C., all acid sites are probed with pyridine, whereas at relatively high temperature, such as 350° C., only the strong acid sites remain probed with pyridine. Acidity types and strengths are indicated herein using an ‘L’ or a ‘B’ to indicate either Lewis of Bronsted acidity, respectively, and the subsequent number indicates the temperature at which the pyridine is desorbed from the zeolite. As such, ‘B350’ is the Bronsted acidity of the zeolite-Y as measured after pyridine desorption at 350° C. ‘L350’ is the Lewis acidity of the zeolite-Y as measured after pyridine desorption at 350° C. ‘B150’ is the Bronsted acidity of the zeolite-Y as measured after pyridine desorption at 150° C. ‘L150’ is the Lewis acidity of the zeolite-Y as measured after pyridine desorption at 150° C. Resulting values are in μmol per gram of zeolite, as is the activity number (B350-L350). The selectivity number [(B350+L350)/(B150+L150)] relates the strong acidity to the total acidity, yielding the fraction of strong acidity, and is without unit.

A “classical” in situ infrared cell is used as described in Journal of Catalysis 385 (2020) 52-60, with the option to heat the lower measuring area. FIG. 1 shows the classical configuration used to analyze the acidity of faujasites with pyridine adsorbed using in situ infrared spectroscopy. (1) Connection to vacuum. (2) Quartz sample holder (able to be lowered to the dashed circle position). (3) Upper heating element. (4) Sample wafer. (5) Quartz body of the cell. (6) Lower heating element. (7) Incoming infrared signal. (8) KBr windows. (9) DTGS Detector. The applied working method follows the recommendations set out in said work and follows the following steps:

A first step to measure the zeolite's acidity using FTIR spectroscopy using pyridine as probe molecule regards the making of the self-supported wafer or disc through which the IR signal travels. These are made from free-flowing powders, with particle size in the range of 1-10 μm, which are compressed into self-supported wafers or discs with cross-section surfaces of 1-3 cm² of homogeneous thickness, using an hydraulic press and a die, with the amount of sample ranging from 5-15 mg per cm², using a pressure of at most 500 kgs per cm². The weight of the wafer is noted and corrected for weakly adsorbed water in the range of room temperature to 200° C.

The second step regards the placement of the wafer into the body of the cell, followed by the activation, also referred to as ‘degassing’, by heating to 400° C. using a ramp of 25° C./min, a dwell time of 12 h, and application of a dynamic vacuum better than 0.01 mbar. After this activation, the sample is cooled down to 150° C., at which point a reference spectrum (Ref. Spect.) is acquired. FIG. 2 is an example of such a reference spectrum, wherein the solid line represents the spectra for a parent USY with SAR 60 and the dashed line represents a ZSM-5 zeolite with SAR 40. Afterwards the sample is cooled down to 50° C.

Next, the sample is saturated at 50° C. with pyridine (>99.5% pure and dried), by introducing pulses of 10 mbar of pyridine into the volume of the cell until the sample is saturated. Saturation is followed by evaluation of the Brønsted and Lewis peaks in the FTIR spectrum, and is typically reached using 10 pulses of 1 min each. Next, physisorbed pyridine species are removed by heating the cell to 150° C. using a ramp of 25° C./min and application of the vacuum, and a dwell time of 120 min. At this stage the spectrum ‘150 Spect.’ is acquired. FIG. 3 is an example of such a 150 Spect. Next, the temperature is increased to 350° C. using a ramp of 25° C./min, combined with a dwell time of 60 min, followed by cooling down to 150° C., after which the spectrum ‘350 Spect.’ is acquired. The obtained spectra after adsorption and desorption of pyridine (150 Spect, and 350 Spect.) are subsequently corrected by subtraction of the reference spectrum (Ref. Spect.), yielding 150 Calc. Spect, and 350 Calc. Spect. FIG. 4 is an example of a 150 Calc. Spect where the spectrum of FIG. 2 is subtracted from the spectrum of FIG. 3.

Subtraction of Ref. Spect. from 150 Spect, and subtracting the corresponding Ref. Spect from the 350 Spect. is executed differently from other zeolites such as ZSM-5. This is because, activated high-SAR pyridine-free parent USY zeolites feature a peak around 1550 cm⁻¹ as shown in FIG. 2. This peak overlaps with the peak associated to pyridine adsorbed to Brønsted acid sites (see also Microporous and Mesoporous Materials 299, 2020, 110114). If not corrected for by the aforementioned subtraction, this peak overestimates B150 and B350 by about 50-80 μmol/g.

Spectra are recorded using a commercially available FTIR spectrometer equipped with industry standard deuterated triglycine sulfate (DTGS) detector, as may be obtained from Nicolet or Thermo, in the range of 6000-1000 cm⁻¹, at a spectral resolution of 4 cm⁻¹ and 64 scans in transmission mode. Integration of the peak areas is done using peak limits for Brønsted acidity of 1565-1515 cm⁻¹ (yielding B150 and B350), the peak limits for Lewis acidity of 1465-1435 cm⁻¹ (yielding L150 and L350), a baseline between those peak limits as illustrated in FIG. 5 using specialized spectrometer software called Omnic from Thermo.

The obtained peak areas are converted into a number of acid sites (nPy in μmol) using the Lambert-Beer equation: A=ε(nPy/S), wherein ‘A’ is the peak area in cm⁻¹, ‘E’ the integrated extinction coefficient in cm/μmol, ‘S’ the surface area of the cross section of the wafer or disc, in cm². The extinction coefficients as reported in J. Catal. 1993, 141, 347-354 are used, being 1.67 cm/μmol for Brønsted sites and 2.22 cm/μmol for Lewis acid sites. This results for the Brønsted acid sites in: nB=(SxAB)/1.67, with nB, the number of measured Brønsted acid sites, in μmol, and AB the peak area of the related to Brønsted acidity, in cm−1.

With nB known, the weight-based Brønsted acid site density (in μmol per gram), B, is obtained by dividing by the weight of the wafer or disc: B=nB/w, wherein ‘w’ is weight of the wafer or disc, in g, on dry basis. The Brønsted acid site density after pyridine desorption at 150° C. or at 350° C., are designated as ‘B150’ or ‘B350’, respectively. A similar derivation is done for the Lewis acid site density, yielding the equations nL=(SxAL)/2.22 and L=nL/w, with ‘AL’ the peak area of the related to Lewis acidity, in cm⁻¹, ‘nL’ the number of measured Lewis acid sites, in μmol, and ‘L’ the Lewis acid site density, in μmol/g. Finally, the Lewis acid site density after pyridine desorption at 150° C. or at 350° C., are designated as ‘L150’ or ‘L350’, respectively.

FIGS. 2-5 are an illustration of spectra of the same zeolite-Y used in the method to determine the L150 and B150. The above description to measure B150, B350, L150, and L350 are summarized as follows in Table A:

TABLE A

| Step | Description | Key condition |
|---|---|---|
| 1 | Making of the self- | Free flowing powder of particle size 1-10 um, |
| | supported disc | amount of sample 5-15 mg/cm², pressure applied |
| | | at most 500 kgs/cm² |
| 2 | Spectrometer | Commercial FTIR spectrometer equipped with |
| | | DTGS detector in transmission mode |
| 3 | Activation of the | At 400° C. for 12 h, followed by taking reference |
| | sample | spectrum |
| 4 | Pyridine adsorption | Sample at 50° C., pulses of 10 mbar for 1 min until |
| | | saturation |
| 5 | Pyridine desorption | Sample at 150° C. for 120 min, followed by taking |
| | | 150 C. spectrum, followed by heating to 350° C. for |
| | | 60 min, followed by taking 350 C. spectrum |
| 6 | Spectra acquisition | 6000-1000 cm⁻¹, 4 cm⁻¹ resolution, 64 scans |
| 7 | Spectra processing | Subtraction reference spectrum from 150 C. and |
| | | 350 C. spectrum. Integration of peak for Brønsted |
| | | acidity at 1565-1515 cm⁻¹, and Lewis acidity at |
| | | 1465-1435 cm⁻¹. |
| 8 | Calculation of | Lambert-Beer law, using peak areas (in cm⁻¹), the |
| | values | surface area of the cross section of the wafer (in |
| | | cm²), the humidity-corrected weight of the wafer |
| | | (in g), and extinction coefficients 1.67 cm/μmol for |
| | | Brønsted acidity and 2.22 cm/μmol for Lewis |
| | | acidity. |

### End of Section A

The selectivity number of the zeolite-Y is greater than 0.50 and preferably greater than 0.55 and even more preferably greater than 0.60.

Applicants further found that the difference between the B350 and the L350 is a measure of the activity of the zeolite-Y. This activity number, being the B350 minus the L350 values, is preferably greater than 40 μmol/g and may range from 40 to 150 μmol/g, and more preferably from 60-120, and most preferably from 80-100 μmol/g. A too great activity number can lead to overcracking and accordingly a reduced selectivity to middle distillates.

The zeolite-Y according to the invention is suitably obtained by a mesoporization process starting from a parent zeolite-Y as described below. Preferred mesoporization processes are processes in which the selectivity number increases with respect to the starting parent zeolite-Y and wherein the activity number remains about the same and preferably increases with respect to the starting parent zeolite-Y. Preferred mesoporization processes, such as described below, increase the activity number by at least 5 μmol/g, preferably at least 10 μmol/g, and more preferably at least 15 μmol/g and/or increase the selectivity number by at least 0.02, preferably by at least 0.05 and most preferably at least 0.10.

The starting parent zeolite will be a zeolite-Y and therefore have a faujasite structure. Applicants found that the properties of the starting zeolite-Y are important to achieve both the desired increase in the selectivity number and the desired increase in the activity number with respect to the starting parent zeolite-Y. The SiO₂/Al₂O₃ ratio of the starting zeolite Y is suitably higher than 15, preferably higher than 20 most preferably higher than 30 and lower than 100 mol/mol. The starting zeolite Y suitably has a pore volume of between 0.45 and 0.55 ml/g. The mesopore volume of the starting zeolite Y is suitably between 0.20 and 0.30 ml/g. The micropore volume is suitably greater than 0.18 ml/g and preferably between 0.20 and 0.35 ml/g. The total surface area of the starting zeolite Y may range between 500 and 1030 m²/g and is suitably below 800 m²/g and preferably below 750 m²/g and above 700 m²/g. The unit cell size of the starting zeolite Y is suitably below 24.40 Å and preferably between 24.22 Å and 24.32 Å. Examples of possible parent zeolite-Y are described in US2004141911. Suitable parents may result from the upgrading of sodium Y zeolites via established combinations of ion exchanges, steam treatments, and acid treatments. The parent zeolite may be a commercially obtainable zeolite-Y such as for example CBV720, CBV760, and CBV780 as may be obtained from Zeolyst International, 360HUA and 385HUA as may be obtained by Tosoh Corporation, or others from various suppliers such as PIDC, Jalon and Sinopec RIPP. The parent zeolite may be derived from a material which features the right unit cell size but a SAR below 15, such as CBV600 or CBV712. In this case, prior to executing the base treatment, the material is dealuminated using mineral acids, such as HCl or HNO₃, to achieve the desired molar SAR or at least 15.

In view of the above the invention is also directed to a process to prepare a modified zeolite-Y having a micropore volume greater than 0.18 ml/g, a mesopore volume greater than 0.35 ml/g, a total surface area greater than 600 m²/g starting from a starting zeolite Y, wherein the starting zeolite-Y has a SiO₂/Al₂O₃ ratio of greater than 15 mol/mol, a unit cell size smaller than 24.40 Å, a micropore volume greater than 0.18 ml/g, a mesopore volume smaller than 0.30 ml/g and a total surface area of between 500 and 1030 m²/g, comprising the following steps:
(a) gradually contacting a solid base or a base solution with the starting zeolite Y to obtain an intermediate alkaline-treated zeolite Y, and
(b) contacting the intermediate alkaline-treated zeolite Y with an acid to obtain the modified zeolite Y and
(c) calcination at a temperature of at least 500° C. of the intermediate alkaline-treated zeolite Y obtained in step (a) prior to performing step (b) or calcination at a temperature of at least 500° C. of the modified zeolite Y obtained in step (b),
wherein in step (a) a protective agent is present in the base solution and/or with the starting zeolite Y and wherein said protective agent comprises:
i) a quaternary ammonium cation, of which the longest carbon chain consists of at most 6 carbon atoms, and/or
ii) an alkylamine, of which the longest carbon chain consists of at most carbon 4 atoms.

Applicants found that by using this process the novel modified zeolite Y according to this process may be obtained having the desired combination of selectivity and activity. The application of the claimed protective agents result in a more crystalline zeolite Y. Applicants found that the application of the prior art protective agents like tetraalkylammonium cations (TAAs) with carbon chains of 10 and longer display micelle-forming properties, which are undesired when preparing a zeolite Y for the preferred application as part of a hydrocracking catalyst. It has been found that the use of quaternary ammonium cations having alkyl groups with 7 or more carbon atoms, such as cetyltrimethylammonium, result in a zeolite-Y not having the desired selectivity and activity number according to this invention as illustrated by Experiments C and K in the below Examples. It is believed that cetyltrimethylammonium facilitates precipitation of silicon species into non-zeolitic amorphous or ordered species such as MCM-41, which result in a relatively low and weak acidity of the resulting zeolite Y.

A further advantage is that the claimed process the amount, expressed in weight, of protective agents can be significantly reduced, thereby also reducing the risk of explosion during the subsequent calcination step. By using tetraalkylammonium cations of which the longest carbon chain is at most 6 carbon atoms long as a protective agent, the amount of deposited organics may be a factor 2 to 3 lower as compared to the above referred to prior art publications. By using alkylamines of which the longest carbon chain consists of at most 4 carbon atoms as protective agent, the amount of deposited organics may even be a factor 4-6 lower as compared to the above referred to prior art publications. The application of these preferred protective agents reduce the explosivity risks during calcination by a factor 2 to 6, as compared to the risks disclosed in WO2021185721. The process herein disclosed accordingly enables a relatively safe calcination on the powder as prepared in step (a) and preferably in step (b), and does not require dilution of the organic-containing zeolite phase using binders, such as disclosed in WO2021185721.

In this process the modified zeolite-Y and/or the starting zeolite-Y may have the preferred micropore volume, mesopore volume, total surface area, SiO₂/Al₂O₃ ratio and/or unit cell size as described for the novel zeolite-Y of this invention.

Step (a) is performed wherein also a protective agent is present. The protective agent can be already present with the starting zeolite Y at the start of performing step (a). Alternatively, it may be added concomitantly during the gradual contacting with a solid base or a base solution.

Suitable protective agents are quaternary ammonium cations having the general formula of R1R2R3R4N+, wherein R1-R4 are the same or different alkyl groups having 1 to 6, preferably 1-4, carbon atoms. Examples of suitable quaternary ammonium cations are tetramethylammonium, tetraethylammonium, tetrapropylammonium and tetrabutylammonium. The counter anion of the quaternary ammonium cations may be any anion such as halides or hydroxides

Examples of suitable alkylamines are monoethylamine, monopropylamine, monoisopropylamine, monoisobutylamine, monobutylamine, dimethylamine, diethylamine, dipropylamine, dibutylamine, ethylene diamine, trimethylamine, triethylamine, tripropylamine, and tributylamine.

Preferred organic protective agents are quaternary ammonium cations such as tetrapropylammonium and tetrabutylammonium cations. The amount of protective agent will depend on the specific protective agent and the properties of the starting zeolite-Y. The purpose of the protective agent is to protect the fragile faujasite structure from amorphization during the dissolution taking place at the external surface during the alkaline treatment. For this reason, it is preferred to add enough protective agent to cover a sufficient portion of the external surface of the zeolite. Effective ranges of protective agents (in g) to starting zeolite (in g) ratios are 0.01 to 10 gram per gram, preferably 0.05 to 1 gram per gram, more preferably 0.1 to 0.5 gram per gram.

The starting zeolite may be present on a membrane as in FIG. 2 of US20211711356. The base solution will then flow through the layer or cake, also referred to a fixed bed configuration, of starting zeolite Y. Similar to the process detailed above, the protective agent can be already present with the starting zeolite Y prior to the gradual contacting with a base solution and/or added concomitantly during the gradual contacting with a base solution. By dosing the base solution a gradual or step wise contacting may be achieved. This preferred manner of performing step (a) is advantageous because the intermediate alkaline-treated zeolite Y is substantially separated from the base solution when step (a) is performed.

In Step (a) the solid base or a base solution may alternatively be gradually added to an aqueous suspension comprising the starting zeolite Y and the optional protective agent to obtain an intermediate alkaline-treated zeolite Y. Herein, gradual addition of base with a zeolite is different compared to the state of the art contacting. Typically, in the state of the art, a total amount of base is contacted with a total amount of zeolite directly, that is, in one go, over a period smaller than one minute, typically by adding the zeolite powder, in one go, to a prepared alkaline solution. As such, the maximum amount of base contacted with the total amount of zeolite over a period of one minute is 100% of the total amount of base. Herein, in step (a), the total amount of base is gradually or stepwise contacted with the total amount of zeolite over a longer time period, preferably at least 2 minutes, more preferably at least 5 minutes, and most preferably at least 10 min, such that the maximum amount of base added to the zeolite over a period of one minute in the time period is preferably at most 50%, more preferably at most 20%, and most preferably at most 10% of the total amount of base added to the zeolite in step (a).

The gradual contacting of the base solution may be performed in a time period of between 15 seconds and 60 minutes, preferably between 2 and 45 minutes, and most preferably between 5 and 30 minutes, wherein the addition may be continuous or intermittently. Base addition rates can be expressed as mol of base added per gram of starting zeolite per minute, and are preferably below 5 mmol g⁻¹ min⁻¹, more preferably below 3 mmol g⁻¹ min⁻¹, and most preferably below 1.5 mmol g⁻¹ min⁻¹. The ratio between the starting zeolite and the total liquid volume at the end of step (a) can be between 1 and 300 g parent zeolite Y per liter. This is also referred to as the solid-to-liquid ratio or SLR. Effective ranges of base (in mmol) to starting zeolite (in g) ratios are 0.1 to 15 mmol per gram, preferably 2 to 8 mmol per gram.

The intermediate alkaline-treated zeolite Y as obtained in step (a) can be suitably separated from the suspension by known separation processes such as filtration and/or by using centrifugal forces.

The base solution may be an aqueous solution comprising the following bases NaOH, KOH, CsOH, LiOH, NH₄OH and combinations hereof. The concentration may be between 0.01 and 5.0 M. The pH of the reaction medium in step (a) may vary between 9 and 13.5, more preferably in the range of 10 to 13, and most preferably in the range of between 11 and 12.5. The reaction medium being the zeolite and the aqueous phase which is in contact with the zeolite, including the fraction of solid base or base solution already brought in contact with the zeolite while performing step (a). Temperature at which step (a) is performed may vary between ambient temperature to 100° C. The pressure at which step (a) is performed may vary from ambient pressure to 10 bar, and is preferably ambient pressure. The contacting of the solid base, being anhydrous or hydrated bases such as NaOH, KOH, LiOH, and CsOH in the solid state, with the zeolite can be achieved preferably by adding the solid base to the reaction medium which is in contact with the zeolite. Herein, step (a) commences the first moment part of the total amount of the alkaline solution or solid base is co-present with part of the total amount of zeolite in the reaction medium, and step (a) is finished when the base-treated zeolite is separated from the reaction medium, using for example filtration or centrifugation steps.

In Step (b) an acid is contacted with the intermediate alkaline-treated zeolite Y to obtain the modified zeolite Y. The acid is preferably a mineral acid from the list of HCl, HNO₃, H₂SO₄, H₃PO₄, H₃BO₃, or an organic acid from the group consisting of oxalic acid, malic acid, citric acid, acetic acid, benzoic acid, formic acid, ethylenediaminetetraacetic acid, disodium ethylenediaminetetraacetic acid, monosodium citrate, disodium citrate, or any combination hereof. The acid may be a liquid, such as a concentrated or diluted mineral acid aqueous solution, or a solid, such as for example a solid organic acid. The concentration of the acid in solution may be between 0.01 and 5.0 M. The pH of the reaction medium in step (b) may vary between −2 and 6, preferably in the range of 0-4. The reaction medium being the zeolite and the aqueous phase which is in contact with the zeolite, including the fraction of solid acid or acidic solution that has been already brought in contact with the zeolite while performing step (b). Temperature at which step (b) is performed may vary between ambient temperature to 100° C. The pressure at which step (b) is performed may vary from ambient pressure to 10 bar, and is preferably ambient pressure. Herein, step (b) commences the first moment part of the total amount of the acid is co-present with part of the total amount of zeolite in the reaction medium, and step (b) is finished when the acid-treated zeolite is separated from the reaction medium, using for example filtration or centrifugation steps.

The contacting with the acid and the intermediate alkaline-treated zeolite Y can be performed in a conventional direct contacting method, wherein the zeolite, optionally present as part of an aqueous slurry, is directly, that is, in one go, contacted with the aqueous solution of the acid. Preferably, and similarly as described for the base treatment, a gradual contacting of the alkaline-treated zeolite Y with the acid is executed, especially when the contacting with the acid is performed at a larger scale. The acid treatment in step (b) may be performed in a time period of between 15 seconds and 300 min, preferably 2 to 60 min, and most preferably 5-30 min, wherein, in the case of a gradual acid addition, the addition may be continuous or intermittently. Acid addition rates can be expressed as mol of acid added per gram of intermediate alkaline-treated zeolite per minute, and are preferably below 3 mmol g⁻¹ min⁻¹, more preferably below 2 mmol g⁻¹ min⁻¹, and most preferably below 1 mmol g⁻¹ min⁻¹. Like for the base treatment, the solid-to-liquid ratio can be between 1 and 300 g alkaline-treated zeolite Y per liter. Effective ranges of acid (in mmol) to alkaline-treated zeolite (in g) ratios are 0.1 to 10 mmol per gram, preferably 1 to 6 mmol per gram.

During the application of the sequence of the gradual base treatment in the presence of tetraalkylammonium cations or alkylamines followed by the acid treatment to the parent USY zeolites with SAR exceeding 15 and unit cell size smaller than 24.40 Angstrom, the unit cell size remains largely the same. Typical changes are in the order of 0.01 Angstrom.

The obtained modified alkaline-acid treated zeolite Y as obtained in Step (b) can be suitably separated from the suspension by known separation processes such as filtration and/or by using centrifugal forces.

The invention offers a large advantage over the state of the art when the base treatment is executed in a gradual fashion as described above. Gradual base treatments lead to a more controlled exposure of the zeolite to the base, minimizing negative undesired side effects, such as fragmentation of the zeolite crystal, and in general amorphization as in US20210171356. Accordingly, the resulting suspension from step (a) can be more easily and faster processed, for example by means of a faster filtration. This faster processing, in turn also prevents undesired amorphization of the zeolite due to prolonged exposure to base.

In the state of the art, using direct alkaline treatments, not being a gradual, incremental or stepwise treatment, the quality of a mesoporous base-treated USY deteriorates rapidly when increasing the synthesis scale from several grams towards industrially relevant piloting amounts of above 50 g, and most preferably above 500 g. It is believed that this results from processing difficulties, such as lengthy mixing of the powder into an alkaline solution and lengthy filtrations, which tend to increase with scale as disclosed in US20210171356. In contrast, applicants found that when the gradual base and subsequent acid step are used that the scale of synthesis does not negatively influence the material properties significantly. Accordingly, step (a) and step (b) are preferably executed on batches of at least 50 g, preferably at least 100 g, and more preferably at least 1 kg of parent or intermediate alkaline-treated zeolite Y respectively.

In step (c) the modified zeolite Y obtained in step (b) is calcined at a temperature of at least 500° C. In calcination step (c) the protective agents, tetraalkylammonium cations or alkylamines as bound to the external surface of the zeolite are removed. Calcination in step (c) may be executed at 500-600° C., using either inert or oxidative atmosphere, preferably air, over a period of 2-6 hours. On lab scale this can be done is an ashing oven, whereas on industrial scale a rotary calciner may be used. The calcination may be done on the intermediate alkaline-treated zeolite Y obtained in step (a) prior to performing step (b) or directly after the acid treatment of Step (b). Calcination may also be performed when the modified zeolite Y is shaped with a binder when preparing a catalyst. Calcination may also be performed after a hydrogenation metal is impregnated on the shaped zeolite-Y-binder shaped particle. Preferably the modified zeolite Y obtained in step (b) is calcinated. Most preferably directly after performing step (b).

In view of the favorable catalytic activity and selectivity to middle distillates the invention is also directed to the use of the zeolite Y according to this invention or obtained by the processes of this invention as part of a hydrocracking catalyst composition.

The application of a zeolite-Y in a hydrocracking catalyst and in a hydrocracking process is well known. The novel zeolite-Y of this invention can be advantageously used in such known hydrocracking compositions and provide improved yields to middle distillates and activity when applied in a hydrocracking process. Such a hydrocracking catalyst suitably comprises the zeolite Y according to this invention or obtainable by the process of this invention, an old-IUPAC Group VIII metal and a binder. The Group VIII metal is suitably platinum, palladium, nickel or cobalt.

The binder preferably comprises, and preferably even consists of, one or more non-zeolitic inorganic oxides. Preferably, the non-zeolitic inorganic oxide(s) make up more than 90 wt. of the binder, more preferably more than 95 wt. of the binder. Exemplary non-zeolitic inorganic oxides are alumina, silica, silica-alumina, zirconia, clays, aluminium phosphate, magnesia, titania, silica-zirconia and silica-boria. Preferably, the binder comprises a component selected from the group consisting of silica, alumina and amorphous silica-alumina.

Typically, the content of binder is between 50 to 95 wt % on the total of binder and zeolite-Y.

When the Group VIII metal is palladium and/or platinum the total amount of platinum and/or palladium present in the catalyst is suitably in the range of from 100 ppm to 5.0 percent by weight calculated as element based on total weight of the catalyst, more suitably in the range of from 0.1 to 2.0 percent by weight. If both present, the weight ratio of platinum to palladium (calculated as element) may vary within wide limits, but suitably is in the range of from 0.05 to 10, more suitably 0.1 to 5. In one preferred embodiment of the present invention the catalyst comprises platinum as the sole catalytically active metal, whilst in another preferred embodiment of the present invention the catalyst comprises a combination of platinum and palladium. Platinum and palladium may be present as element, as oxide and/or as sulphide.

Preferably the hydrocracking catalyst comprises a non-noble Group VIII metal and a group VIB metal. The non-noble Group VIII metal is suitably nickel or cobalt. The group VIB metal is suitably molybdenum or tungsten. Examples of suitable combinations are nickel-tungsten, nickel-molybdenum and cobalt-molybdenum. The content of non-noble group VIII metals oxide is preferably between 0.1 and 20 wt %, more preferably between 1 and 10 wt %, most preferably between 2 and 8 wt %. The content of group VIB metal oxide is preferably between 0.1 and 40 wt %, more preferably between 1 and 35 wt %, most preferably between 10 and 30 wt %. The binder may be silica, silica-alumina or alumina. Examples of hydrocracking catalyst compositions for zeolite-Y containing catalysts are described in US20110100875, WO2011069150, WO2022162680, WO2021185721. The hydrocracking catalysts described in these publications may be advantageously prepared using the zeolite-Y according to the invention. The content of the zeolite-Y in the catalyst is preferably between 5 and 50 wt %, preferably between 5 and 35 wt %.

The catalyst may be pre-sulphided hydrocracking catalyst.

The invention is also directed to a process to prepare middle distillates by contacting a hydrocarbonaceous feedstock boiling for more than 90 wt % above 350° C. under hydrocracking conditions with a hydrocracking catalyst of this invention. Hydrocracking of various feedstocks is a well-known refinery unit operation to prepare middle distillates, such as kerosene and gas oil from petroleum derived feedstocks.

Hydrocarbonaceous feedstocks refers to a mixture composed mostly of hydrocarbon compounds. Hydrocarbonaceous feedstock may include, crude oil, atmospheric residues, atmospheric distillates, vacuum distillates for example vacuum gas oil (VGO), Light Cycle Oil (LCO) obtained from catalytic cracking unit, a feed obtained after extraction of aromatics from base oil or lubricating oil, a feed obtained after solvent dewaxing of base oil or lubricating oil, thermally cracked oil, coal-derived distillates, light or heavy coker gas oil, deasphalted oil, demetallized oil, animal oil and fat, triglycerides, carboxylic acids, carboxylic esters, fatty acid alkyl esters, Fischer-Tropsch derived stream, pyrolysis oil of plastic waste and/or biomass, vegetable oil, used cooking oil, and any combination thereof. All of the above mentioned feedstocks may optionally contain metals, and/or nitrogen, and/or oxygen and/or sulphur. The list hereinabove is non-exhaustive. Hydrocracking basically involves catalytically converting hydrocarbon molecules into smaller hydrocarbon molecules in the presence of hydrogen. The hydrocracking catalyst is suitably present as part of a fixed bed of catalyst in a hydrocracking reactor. Hydrocracking conditions usually comprise temperatures in the range of from 250 to 500° C., hydrogen partial pressures in the range of from 1 to 300 bar, weight hourly space velocities of from 0.1 to 10 kg feed per litre of catalyst per hour and gas/feed ratios of from 100 to 5000 NI of gas per kg of feed.

The catalyst is preferably used to convert hydrocarbonaceous feedstocks boiling substantially above 360 C and preferably boiling for 90 wt % above 360 C. The catalyst may be used in a base oil hydrocracker which main products are base oil fractions and which process operates at a feed conversion of below 50 wt percent % and more typically between 20 and 40 wt % percent. Preferably the hydrocracking catalyst is used in a fuels hydrocracker process which main products are preferably naphtha, kerosene and gas oil and wherein the feed conversion is above 40 wt %. The conversion is expressed in the weight percentage of the fraction in the feed which boils above 360 degrees centigrade which are converted to products boiling below 360 degrees centigrade.

Preferably the fuels hydrocracker is operated in two steps, consisting of a preliminary hydrotreating step followed by a hydrocracking step. In the hydrotreating step nitrogen and sulphur are removed and aromatics are saturated to naphthenes. In the hydrocracking step the heavier fraction of the feedstock boiling at a temperature higher than 360° C. is cracked to lower boiling range products such as gas, naphtha, kerosene and diesel.

The invention is relevant for hydrocracking in the absence of the products from the hydrotreating step, being ammonia and H₂S, referred to as ‘sweet mode’. Yet also in the presence of these species, referred to as ‘sour mode’, the benefits, that is, the increased yield of middle distillates, can be achieved.

The invention will be illustrated by the following non-limiting examples. In the below examples various parent zeolite-Y were used, all provided by Zeolyst and Tosoh. The properties of these starting parent zeolites are listed in Tables B, 1, 3, and 3a. Other chemicals were purchased from Fisher Scientific and Sigma-Aldrich and used as received. All below-described wet treatments involve rigorous stirring using magnetic or mechanical stirrers, typically around 250 rpm.

TABLE B

| | | Unit cell |
|---|---|---|
| Reference herein | Reference supplier | size / Angstrom |
| P1 | ‘CBV720’ | 24.28 |
| P2 | ‘CBV760’ | 24.24 |
| P5 | ‘CBV780’ | 24.24 |
| P6 | ‘CBV712’ | 24.35 |
| P7 | ‘HSZ-390HUA’ | 24.26 |

### EXAMPLE 1

An aqueous solution containing 40 g of tetrapropylammonium bromide (TPABr) and 2000 mL of water was prepared, placed in a stirred round bottom flask and heated to 80° C. To this aqueous solution, 100 g of Powder Ref P1 (CBV720 zeolite) were added, and subsequently an extra 250 m¹ water was added to the suspension. To this suspension 750 mL of 0.8M sodium hydroxide (NaOH) aqueous solution was gradually added at a constant rate during 30 min using a peristaltic pump at a temperature of 80° C. and at ambient pressure.

Once the addition was finished, the suspension was immediately filtered on a

Büchner, the cake consisting of the intermediate alkaline-treated zeolite-Y was thoroughly washed with water.

The obtained cake was immediately resuspended in 1200 mL of water at 65° C. The temperature was kept constant until the next filtration step.

Then, 400 mL of 0.6 M hydrochloric acid (HCl) aqueous solution was added to the suspension at a constant rate using a peristaltic pump for 1 h.

Once the addition was finished, the suspension was immediately filtered on a Buchner, the cake was thoroughly washed with water.

The obtained zeolite cake was then dried for 16 h in an oven at 110° C. Finally, the solid was calcined in air for 5 h at 550° C. using a ramp of 5° C./min producing the mesoporous H-USY Powder of Example 1.

Bulk Silica Alumina Ratio (SAR) was determined by X-Ray Fluorescence spectroscopy using a WD-XRF spectrometer.

The thus measured properties of the mesoporous H-USY Powder of Example 1 are listed in Table 1 as Example 1 Powder.

### EXAMPLE 2

Example 1 was repeated except that: Powder ref P2 (CBV760) was used instead of Powder Ref P1 (CBV720), the concentration of the NaOH aqueous solution was 0.6 M instead of 0.8 M, and that the cake consisting of the intermediate alkaline-treated zeolite-Y was resuspended in 1100 mL of water and 370 mL of 3.2 M HCl, instead of 400 mL of 0.6 M HCl.

The measured properties of the mesoporous H-USY Powder of Example 2 are listed in Table 1 as Example 2 Powder.

### EXAMPLE 3

Example 2 was repeated except that the concentration of the NaOH aqueous solution was 0.4 M instead of 0.6 M and that the cake consisting of the intermediate alkaline-treated zeolite-Y was resuspended in 1440 mL of water and that 480 mL of 0.4 M HCl were used instead of 370 mL of 3.2 M HCl. The measured properties of the mesoporous H-USY Powder of Example 3 are listed in Table 1 as Example 3 powder.

### Comparative Experiment A

A Powder Comparative Exp-A was prepared as in Example 1 except that no acid treatment was executed and that additionally an ion exchange was conducted immediately after the filtration following the alkaline treatment. To do so, the obtained cake was immediately resuspended in an aqueous solution containing 109 g of (NH₄)₂SO₄ and 1650 mL of water at room temperature. After 1 h the suspension was filtered on a Büchner. This ion exchange procedure was additionally repeated twice. The final cake was washed thoroughly with water, before being dried and calcined as in Example 1.

The measured properties of the mesoporous Powder Comparative Exp-A are listed in Table 1 as Exp A powder.

### Comparative Experiment B

A Powder Comparative Exp-B was prepared as in Example 2 except that no acid treatment was executed and additionally an ion exchange was conducted immediately after the filtration following the alkaline treatment. To do so the obtained cake was immediately resuspended in an aqueous solution containing 100 g of (NH₄)₂SO₄ and 1500 mL of water at room temperature. After 1 h the suspension was filtered on a Büchner. This ion exchange procedure was additionally repeated twice. The final cake was washed thoroughly with water, before being dried and calcined as in Example 1.

The measured properties of the mesoporous Powder Comparative Exp-B are listed in Table 1 as Exp B powder.

### Comparative Experiment C

A Powder Comparative Exp-C was prepared following the procedure to prepare material “MZ1” as described on pages 13-14 of WO2021185721 with the addition that an acid treatment was executed prior to the calcination step, as described on page 14 of WO2021185721 for the “MZ2” material. Accordingly, the cake obtained after the filtration step following the base treatment was resuspended in a solution containing 9.2 g of 65% HNO₃ and 600 mL of water at 70° C. After 1 h at 70° C., the stirred suspension was filtered and the cake thoroughly washed with water. The obtained zeolite cake was then dried for 16 h in an oven at 110° C., finally the solid was calcined in air for 5 h at 550° C. using a ramp of 5° C./min producing the mesoporous Powder Comparative Exp-C.

The measured properties of the mesoporous Powder Comparative Exp-C are listed in Table 1 as Exp C Powder.

### Comparative Experiment D

A Powder Comparative Exp-D was prepared following the procedure for preparing FAU15-AT2-AW described by M. Milina et al. in Catalysis Today, 2014, 235, 176-183.

The measured properties of the mesoporous Powder Comparative Exp-D are listed in Table 1 as Exp D powder.

TABLE 1
Powder parent references, inventive and comparative examples.

| | SBET | Vmicro, | Vmeso, | Vpore, | SAR, |
|---|---|---|---|---|---|
| Entry | m²/g | ml/g | ml/g | ml/g | mol/mol |
| Ref P1 (parent) | 791 | 0.31 | 0.23 | 0.54 | 29 |
| Ref P2 (parent) | 767 | 0.26 | 0.28 | 0.54 | 57 |
| Example 1 | 948 | 0.26 | 0.54 | 0.80 | 28 |
| Example 2 | 803 | 0.20 | 0.64 | 0.84 | 54 |
| Example 3 | 786 | 0.21 | 0.46 | 0.67 | 50 |
| Exp A | 926 | 0.24 | 0.55 | 0.79 | 21 |
| Exp B | 749 | 0.22 | 0.65 | 0.87 | 40 |
| Exp C | 852 | 0.21 | 0.39 | 0.60 | 30 |
| Exp D | 672 | 0.18 | 0.52 | 0.70 | 20 |
| Ref P5 (parent) | 719 | 0.24 | 0.28 | 0.52 | 79 |
| Example 9 | 790 | 0.20 | 0.59 | 0.79 | 74 |
| Example 10 | 743 | 0.22 | 0.64 | 0.88 | 41 |
| Example 11 | 849 | 0.21 | 0.57 | 0.77 | 54 |
| Exp E | 659 | 0.13 | 0.65 | 0.78 | 68 |
| Exp F | 632 | 0.21 | 0.51 | 0.72 | 26 |
| Exp G | 1005 | 0.22 | 0.71 | 0.94 | 18 |
| Exp H | 889 | 0.25 | 0.62 | 0.86 | 40 |
| Exp I | 743 | 0.21 | 0.44 | 0.65 | 48 |
| Exp J | 830 | 0.21 | 0.97 | 1.18 | na |
| Exp K | 956 | 0.01 | 1.15 | 1.15 | 55 |
| Exp L | 692 | 0.11 | 0.47 | 0.59 | 52 |
| Ref P6 (parent) | 647 | 0.26 | 0.18 | 0.44 | 12 |
| Exp M | 694 | 0.25 | 0.35 | 0.60 | 12 |
| Exp N | 761 | 0.24 | 0.42 | 0.65 | 14 |

### EXAMPLE 6

The Bronsted and Lewis acidity of the parent zeolite-Y powders of the inventive examples and comparative experiments were measured by FTIR after adsorption to saturation and partial desorption of pyridine at 150 and 350° C. following a procedure described below, and as described in Section A. The processing of the obtained spectra is illustrated for B150 and L150 for parent sample ‘P2’ in FIGS. 2-5. A Nicolet 6700 spectrometer equipped with a DTGS detector was used. Samples were pressed into self-supporting wafers and degassed at 400° C. for 12 h in vacuo before measurements. After this time the temperature was lowered to 150° C. and a reference spectra (‘Ref. Spect.’) of the zeolite sample was recorded according to the well-established procedure referred to above and described here below. Then, the samples were subjected to 10 pulses of at least 10 mbar of pyridine at 50° C. for 1 min (until saturation), after which the system was heated to 150° C. for 120 min, followed by the acquisition of the spectra at this same temperature (‘150 Spect.’). The temperature was increased to 350° C. for 60 min, after that the temperature was lowered to 150° C. and a spectra was recorded at this temperature (‘350 Spect.’). To determine B150 and L150, Ref. Spect. was subtracted from the spectra obtained after desorption at 150° C. (150 Spect.) to yield a calculated spectrum (150 Calc. Spect.). The areas of the absorption bands at 1545 and 1455 cm⁻¹ were measured by integrating the 150 Calc. Spect. using a common method known by the person skilled in the art, including the use of a baseline from either side of the absorption bands at 1515 to 1565 cm⁻¹ (for Bronsted acid sites) and 1435 to 1465 cm⁻¹ (for Lewis acid sites). The value of the areas obtained are correlated to the number of acid sites in μmol (B150 and L150) using the equation derived from the Beer-Lambert law described in Journal of Catalysis 385 (2020) 52-60 and the integrated molar extension coefficient determined by Emeis, J. Catal., 1993, 141, 347-354. The obtained number of acid sites in μmol are converted in μmol/g using the weight of the self-supported wafer in g. A similar procedure was applied to determined B350 and L350 from the spectra recorded after pyridine desorption at 350° C. (350 Spect.). The way of working is summarized in Section A, Table A, Table 2, and FIGS. 1-5 for clarity. FIG. 2 shows that the reference spectrum (Ref. Spect.) contains a peak around 1550 cm⁻¹. The spectrum in FIG. 3 is obtained after pyridine adsorption and desorption at 150C spectrum: ‘150 Spect’, containing a shoulder around 1550 cm⁻¹. Next, in FIG. 4 from 150 Spect, the Ref. Spect. is subtracted, yielding 150 Calc. Spect, and hereby correcting for the 1550 cm⁻¹ peak. Finally, in FIG. 5, the integration of the Bronsted and Lewis acidity peaks is illustrated.

TABLE 2

| | | | Band limits for peak | |
|---|---|---|---|---|
| | | Band location, cm⁻¹ | integration and baseline | |
| | | (+ Extinction | (cm⁻¹) | |
| Type | Suitable Spectrum | coefficient cm/μmol) | Lower | Higher |
| B150 | 150 Calc. Spect. = | 1545 (1.67) | 1515 | 1565 |
| L150 | 150 Spect − Ref. | 1455 (2.22) | 1435 | 1465 |
| | Spect. | | | |
| B350 | 350 Calc. Spect. = | 1545 (1.67) | 1515 | 1565 |
| L350 | 350 Spect − Ref. | 1455 (2.22) | 1435 | 1465 |
| | Spect. | | | |

The measured values are listed in Table 3 and 3a wherein B350 is the Bronsted acidity of the zeolite-Y as measured by FTIR after pyridine desorption at 350° C., L350 is the Lewis acidity of the zeolite-Y as measured by FTIR after pyridine desorption at 350° C., B150 is the Bronsted acidity of the zeolite-Y as measured by FTIR after pyridine desorption at 150° C., and L150 is the Lewis acidity of the zeolite-Y as measured by FTIR after pyridine desorption at 150° C.

From the acidic properties of the zeolite powders as listed in Table 3 and 3a a graphical representation of the data can be obtained as shows in FIG. 6. The acidity data allows for the following conclusions: The base treated only samples (such as Comparative Experiments A and B) display higher overall acidity (B150+L150) but lower strong acidities (B350+L350) and much lower strong Bronsted acidity (B350) as compared to the examples according to the invention. For example, Example 1 and Example 2 powders according to the invention display a much higher activity and selectivity number. The degree of mesoporosity for the powder according to the invention can be tuned, as demonstrated by the Example 3 powder.

The mesoporization as performed in comparative experiments A-D results in a zeolite Y powder having weaker acidities and therefore lower activity and selectivity number.

TABLE 3

| | B150 | B350 | L150 | L350 | B350 − L350 | (B350 + L350)/ |
|---|---|---|---|---|---|---|
| Entry | μmol/g | μmol/g | μmol/g | μmol/g | μmol/g | (B150 + L150)/— |
| Ref 1 | 231 | 126 | 73 | 41 | 85 | 0.55 |
| (parent) | | | | | | |
| Ref 2 | 129 | 77 | 25 | 15 | 62 | 0.60 |
| (parent) | | | | | | |
| Example 1 | 177 | 113 | 72 | 24 | 89 | 0.55 |
| Example 2 | 105 | 66 | 27 | 17 | 49 | 0.63 |
| Example 3 | 124 | 90 | 32 | 14 | 76 | 0.67 |
| Exp A | 184 | 98 | 88 | 27 | 71 | 0.46 |
| Exp B | 90 | 36 | 34 | 10 | 26 | 0.37 |
| Exp C | 164 | 96 | 69 | 18 | 78 | 0.49 |
| Exp D | 208 | 104 | 101 | 48 | 56 | 0.49 |
| Ref P5 | 74 | 46 | 12 | 6 | 40 | 0.60 |
| (parent) | | | | | | |
| Example 9 | 63 | 56 | 18 | 12 | 44 | 0.84 |
| Example 10 | 93 | 61 | 24 | 11 | 59 | 0.62 |
| Example 11 | 108 | 59 | 21 | 12 | 87 | 0.55 |

TABLE 3a

| | B150 | B350 | L150 | L350 | B350 − L350 | (B350 + L350)/ |
|---|---|---|---|---|---|---|
| Entry | μmol/g | μmol/g | μmol/g | μmol/g | μmol/g | (B150 + L150)/— |
| Exp E | 81 | 37 | 45 | 25 | 12 | 0.49 |
| Exp F | 141 | 72 | 149 | 51 | 21 | 0.43 |
| Exp G | na | na | na | na | 33 | 0.43 |
| Exp H | na | na | na | na | 21 | 0.37 |
| Exp I | na | na | na | na | 6 | 0.31 |
| Exp J | na | na | na | na | 2 | 0.45 |
| Exp K | 22 | 7 | 47 | 17 | −10 | 0.34 |
| Exp L | 77 | 34 | 51 | 25 | 9 | 0.47 |
| Ref P6 | 270 | 160 | 95 | 16 | 144 | 0.48 |
| (parent) | | | | | | |
| Exp M | 470 | 242 | 129 | 35 | 207 | 0.46 |
| Exp N | 416 | 213 | 80 | 32 | 181 | 0.49 |

### EXAMPLE 7

Hydrocracking catalysts samples were prepared using Powder Ref P1 and Powder ref P2 (parents), Example 1, Example 2, Exp A and Exp B powders according to the following similar procedure.

First a catalyst carrier was prepared in the following way:
13 g of dry Pural SB (SASOL) were placed in a twin-screw mixer.
5.1 mL of freshly prepared 1M HNO₃ solution were added.
8.3 mL of deionized water were added.
The paste was mixed for 5 min at 50 rpm.
7 g of dry zeolite powder were added to the mixture.
8.3 mL of deionized water were added.
The paste was mixed from 5 min at 50 rpm followed directly by 15 min at 150 rpm.
The obtained paste was transferred in a single screw extruder equipped with a 3 mm diameter cylindrical dye.
The paste was extruded at 100 rpm.
The obtained cylindrical extrudates were dried at 80° C. for 3 h before being calcined in air for 2 h at 600° C.
The obtained calcined carriers were then cut in to 3-4 mm length cylinders. The hydrogenation function was then added to the carriers by means of Incipient Wetness Impregnation (IWI), to do so the following steps were applied:
The water soaking volume of the to-be-impregnated carrier was determined following methods known by a person skilled in the art.
10 g of dried carrier were placed in a stainless-steel bowl rotating at 15 rpm.
An aqueous solution containing Ni(NO₃)₂·6H₂O and (NH₄)₁₀H₂ (W₂O₇)₆ was prepared. The quantity of metal precursor and volume of water were tuned to yield a final metal content in the catalyst of ca. 5.7 and 21 wt % of NiO and WO₃ respectively.
Impregnation solution was added dropwise at a constant rate in 20 min using a peristaltic pump.
The impregnated extrudates were then rotated at room temperature for an additional 60 min.
The extrudates were dried with a 100° C. air stream while keeping the bowl rotating.
Finally, the extrudates were calcined in air at 500° C. for 1 h.

The obtained samples are summarized in Table 4.

TABLE 4

| | Corresponding powder |
|---|---|
| Catalyst sample | sample |
| Catalyst P1 | Powder Ref P1 |
| Catalyst P2 | Powder Ref P2 |
| Catalyst 1 | Example 1 Powder |
| Catalyst 2 | Example 2 Powder |
| Catalyst A | Exp A Powder |
| Catalyst B | Exp B Powder |

### EXAMPLE 8

The hydrocracking performance of the Catalysts of Example 7 were evaluated under both sweet and sour conditions on a suitable feedstock.

Table 5 describes the physical and chemical properties of the specific feedstock used in sweet conditions.

For the sour conditions, spiking agents were added to the same feedstock. Dimethyl disulfide (DMDS) was used in the right proportion to obtain 1 wt % of S, while a mixture tributylamine (TBA) and acridine were used to obtain 2000 ppm of inorganic N and 20 ppm of organic N respectively.

TABLE 5

| Properties | Method | Value |
|---|---|---|
| Density at 15° C., g/ml | ASTM D 4052 | 0.8551 |
| Na, ppm | ASTM D 5185 | <1 |
| Fe, ppm | ASTM D 5185 | <1 |
| S, ppm | ISO 20846 | 16 |
| N, ppm | ASTM D 5762 | <1 |
| Viscosity at 100° C., cSt | ASTM D 445 | 4.58 |
| Viscosity at 50° C., cSt | ISO 3104 | 15.6 |
| Total Aromatics, wt % | ASTM D 2007 | 26 |
| Boiling range, SimDist | ASTM D 7213 | 0 |
| | 0.5% | 257 |
| | 5% | 317 |
| | 10% | 346 |
| | 20% | 377 |
| | 30% | 398 |
| | 40% | 415 |
| | 50% | 430 |
| | 60% | 445 |
| | 70% | 461 |
| | 80% | 481 |
| | 90% | 509 |
| | 95% | 531 |
| | 99% | 569 |
| | 99.5% | 583 |

A high-throughput reactor unit was loaded with the Catalysts as obtained in Example 7 and listed in Table 4. The catalyst beds were constituted of 3.5 mL of catalysts diluted with silicon carbide (SiC). Gas effluent were measured with an in-line GC while liquid samples were analyzed off-line with various analytical techniques. Cut-off points used to describe the different product obtained are summarized in Table 6.

TABLE 6

| Product nomenclature | Boiling point range | |
|---|---|---|
| C1-C4 (Gas) | C1-C4 | |
| Naphtha | C5-130° | C. |
| Middle distillates (MD) | 130-360° | C. |
| Unconverted Oil (UCO) | >360° | C. |

Prior to the actual hydrocracking reaction, the catalysts underwent a sulfiding procedure known by the person skilled in the art.

The procedure can be summarized as follows:
Catalyst bed were dried under hydrogen atmosphere at 125° C. for 6h.
A spiked Straight Run Diesel (SR Diesel+3 wt % DMDS) was flown through the catalysts bed.
The temperature was raised to 250° C. with a ramp of 15° C./h and kept constant for 8h.
The temperature was again raised to 350° C. with the same ramp and kept constant for 9.5h.
At that time, the flow of liquid was switched to the feedstock described in Table 5, the temperature was lowered or increased to the desired starting reaction temperature.

The conditions of the catalytic tests described herein were as follows:
LHSV (liquid hourly space velocity, space times): 1.5 h⁻¹
Temperatures: 300-330° C. (sweet); 350-385° C. (sour)
Pressure: 140 bar
Hydrogen treat gas rate: 900 Nm³/m³

The catalytic performance in sweet conditions at 60% conversion are summarized in Table 7 which states the weight-based fractions of the products that are collected after the catalytic conversion.

Conversion is defined by the following formula:

$$X = \frac{( UCO Feedstock ) - ( UCO Effluent )}{( UCO Feedstock )} \times 100$$

Where:
X: correspond to the conversion in %
UCO Feedstock and UCO Effluent corresponds to the weight fraction of product boiling at a temperature higher than 360° C. for the feedstock and the effluent respectively as determined using simulated distillation according to the method of ASTM D7213.

TABLE 7

| | Catalyst | | | | | |
|---|---|---|---|---|---|---|
| Parameters | P1 | P2 | 1 | 2 | A | B |
| Temperature, | 321.0 | 326.0 | 319.5 | 323.5 | 323.0 | 329.0 |
| °C. | | | | | | |
| Gas, wt % | 4.3 | 4.7 | 4.1 | 4.0 | 4.2 | 4.4 |
| Naphtha, | 24.8 | 25.9 | 23.8 | 22.9 | 24.6 | 24.8 |
| wt % | | | | | | |
| Middle | 36.5 | 34.9 | 37.9 | 38.7 | 36.9 | 36.4 |
| distillates, | | | | | | |
| wt % | | | | | | |
| UCO, wt % | 34.4 | 34.5 | 34.2 | 34.4 | 34.3 | 34.4 |
| Delta MD, | 0.0^{a} | 0.0^{b} | 1.4^{a} | 3.8^{b} | 0.4^{a} | 1.5^{b} |
| wt % | | | | | | |

^{a}Delta Middle Distillates versus Catalyst P1
^{b}Delta Middle Distillates versus Catalyst P2

Table 8 describes the catalytic performance in sour conditions at 60% conversion.

TABLE 8

Catalyst

| Parameters | P2 | 2 |
|---|---|---|
| Temperature, ° C. | 401.0 | 389.5 |
| Gas, wt % | 4.4 | 4.2 |
| Naphtha, wt % | 19.4 | 17.2 |
| Middle distillates, wt % | 40.6 | 43.3 |
| UCO, wt % | 35.6 | 35.3 |
| Delta MD, wt % | 0.0^{a} | 2.7^{a} |

^{a}Delta Middle Distillates versus Catalyst P2

The testing allows for the following conclusions:
The Inventive samples display both improved activity and MD selectivity as compared to the parent starting zeolites.
The comparative examples display reduced activity as compared to the parent zeolites, and show significantly lower MD benefits as the inventive samples.
The activity number of the mesoporous zeolite powder can be suitably related to the activity of the corresponding catalyst as illustrated in FIG. 7.
The selectivity number of the mesoporous zeolites powder can be suitably related to the MD yield of the corresponding catalyst as illustrated in FIG. 8.
The superior performance can be attained in sweet and in sour mode, where even larger activity benefits may be attained.

### EXAMPLE 9

Was executed exactly like Example 2, with the exception that CBV780 was used instead of CBV760. The resulting material has a high selectivity number of 0.84, suggesting that the desired effect becomes larger for parents with higher molar SARs.

### EXAMPLE 10

Was executed exactly as Example 2, with the exception that the scale was ten times larger. Accordingly, a jacketed 50L reactor combined with a plate filter fitted with 25 plates of 20 cm×20 cm cellulose depth plates was used to execute the treatments and subsequent separations. The obtained material shows that favorable selectivity numbers can be obtained independent of scale.

### EXAMPLE 11

Was executed like Example 2, with the exception that the acid treatment was executed in a direct fashion, as opposed to gradual fashion. Accordingly, the zeolite obtained after the base treatment was added in one go to a pre-heated 1470 mL of a pre-made solution of 0.8 M HCl. This experiment shows that, unlike for the base treatment, the method of contacting the acid, being direct of gradual, is not crucial to obtain the desired acidity profile.

### Comparative Experiment E

Was executed exactly like Comparative Experiment B, with the exception that CBV780 was used instead of CBV760. This experiment demonstrates that the acid treatment is needed to achieve the desired properties of the resulting material.

### Comparative Experiments F to N

In Table 9 known materials obtained by the mesoporization of USY materials of different molars SARs are reproduced exactly accordingly to the experimental protocol in the cited source for each of the reproduced examples.

TABLE 9

| Comparative | | | |
|---|---|---|---|
| Experiment | | Sample code in the source of the | |
| reference | | example that was exactly | Parent |
| herein | Source | reproduced | used |
| F | US20230051097 | ‘E1’ | P1 |
| G | ACS Catal. 2015, | ‘FAU15-H’ | P1 |
| H | 5, 2, 734-743 | ‘FAU30-H’ | P2 |
| I | | ‘FAU40-H’ | P5 |
| J | | ‘FAU385-H’ | P7 |
| K | WO2021185721 | ‘MZ2’ | P2 |
| L | US20130292301 | ‘HYA’ | P2 |
| M | US20210171356 | ‘USY-I-base treated inventive’ | P6 |
| | | (from Table B and Example 34) | |
| N | U.S. Pat. No. 11,325,835 | ‘Example 6’ | P6 |

All these samples display selectivity numbers lower than 0.50, activity numbers lower than inventive samples obtained using inventive processes from the same parent, and the delta of selectivity or activity number between comparative and inventive appears to increase with increasing molar SAR.

From these results can be concluded that the following versions of mesoporization via base (+acid) treatments do not yield materials with the desired acidity:
inorganic protective agents used in a gradual base treatment, such as Mg(NO₃)₂, followed by acid treatment (Exp. F),
direct, that is non-gradual, base treatment (Exps. G, H, I, J, K, L),
the use of TPABr (Exps. G, H, I, J) or cetyltrimethylammonium chloride (CTAC) (Exp. K), as tetraalkylammonium cations sources during direct base treatments,
base treatment in the absence of protective agents (Exp. L),
base treatment not followed by an acid treatment (Exps. G, H, I, J, L),
gradual base treatment in the absence of protective agents followed by direct (Exp M) or gradual (Exp N) acid treatment starting from parent USY zeolites with a SAR that is below 15.

### Comparative Experiment O

The inventors aimed at executing an experiment exactly like Example 10, yet in direct fashion, that is: adding the zeolite to a pre-made pre-heated alkaline solution of NaOH with TPABr in one go. This experiment was aborted after execution of the base treatment as separation of the resulting suspension was not practically feasible due to a large pressure build up and resulting negligible flow rate in the plate filter. This resulted in an estimated time of removing the alkaline media and washing, instead of less than 30 min for Example 10, longer than 1 day.

The selectivity and activity numbers of all inventive and comparative examples plotted as a function of the molar SAR (FIGS. 9 and 10) evidences that only inventive samples achieving selectivity numbers above 0.50.

Moreover, the delta between inventive and comparative in selectivity and activity number increases with molar SAR, and is particularly pronounced in the range of 30-80 mol/mol.

This trend goes directly against the teachings in the state of the art (Chem. Mater. 2013, 25, 9, 1947-1959), where it is reviewed that an acid treatment following a base treatment should benefit preferably faujasites with low SARs, preferably below 10 mol/mol, and not those with SARs above 20 mol/mol.

### BRIEF DESCRIPTION OF THE FIGURES

FIG. 1 shows the classical configuration used to analyze the acidity of faujasites with pyridine adsorbed using in situ infrared spectroscopy. (1) Connection to vacuum. (2) Quartz sample holder (able to be lowered to the dashed circle position). (3) Upper heating element. (4) Sample wafer. (5) Quartz body of the cell. (6) Lower heating element. (7) Incoming infrared signal. (8) KBr windows. (9) DTGS Detector.

FIG. 2 shows Ref. Spect, for a parent USY with SAR 60, P2, whereas the dashed line represents a ZSM-5 zeolite with SAR 40.

FIG. 3 shows 150 Spect, for P2.

FIG. 4 shows Calc. Spect. 150 for P2 obtained by subtraction of Ref. Spect. (FIG. 2) from 150 Spect. (FIG. 3).

FIG. 5 shows the peak integration of AB and AL from Calc. Spect. 150 for P2. Striped areas represent the peak integrals within the peak limits and baselines indicated by the vertical dashed lines.

FIG. 6 shows the activity (B350-L350) and selectivity numbers (B350+L350)/(B150+L150) of the inventive examples as shown as Example X, with grey filled points and comparative experiments shown as Exp X with no fill points.

FIG. 7 shows the correlation between the activity of the Catalyst 1, 2, A & B and the value of the activity number of the corresponding Powders Example 1, 2, Exp. A & B respectively.

FIG. 8 shows the correlation between the selectivity for middle distillates of the Catalyst 1, 2, A & B and the value of the selectivity number of the corresponding Powders Example 1, 2, Exp. A & B respectively.

FIG. 9 shows the selectivity number and FIG. 10 the activity number as a function of the molar SAR for inventive examples (grey fill) and comparative experiments (no fill). Trendlines are standard linear trendlines for the displayed inventive examples (dotted line) and comparative examples (dashed line), as can be generated in Excel.

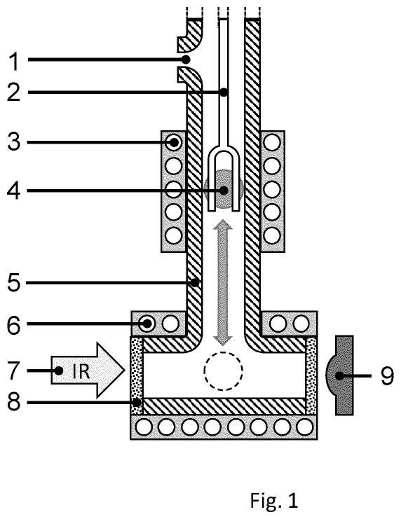

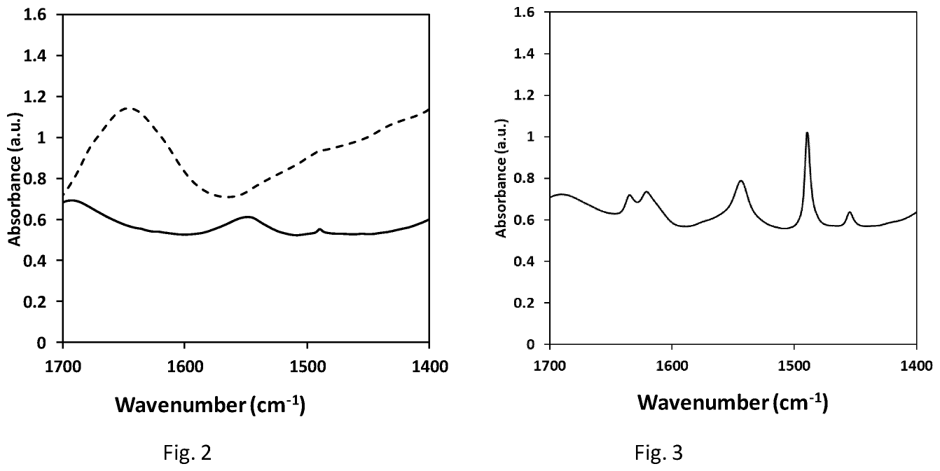

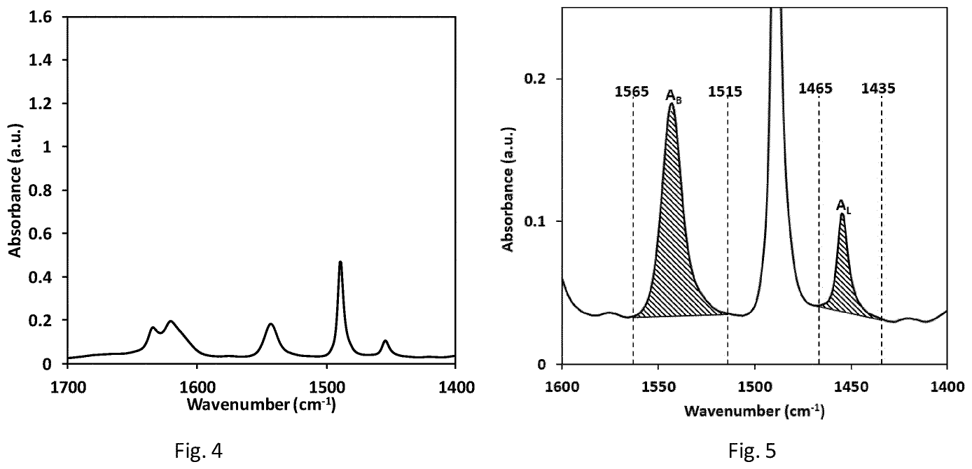

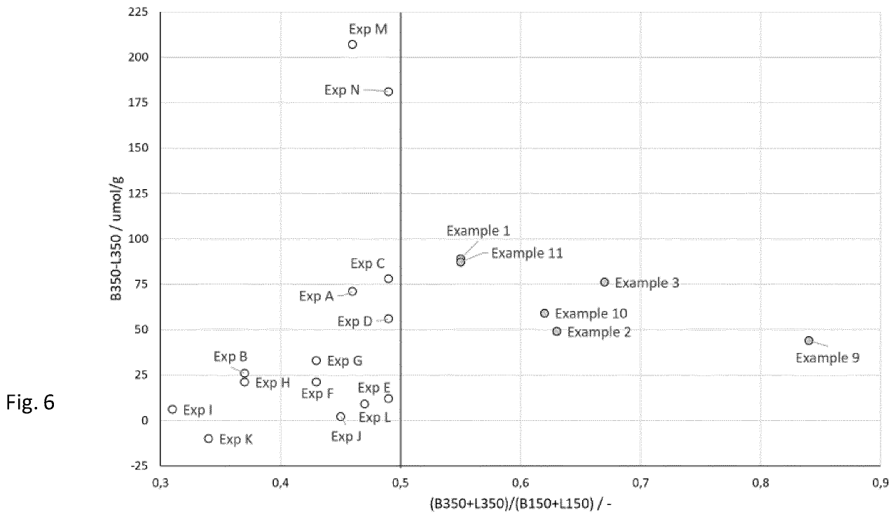

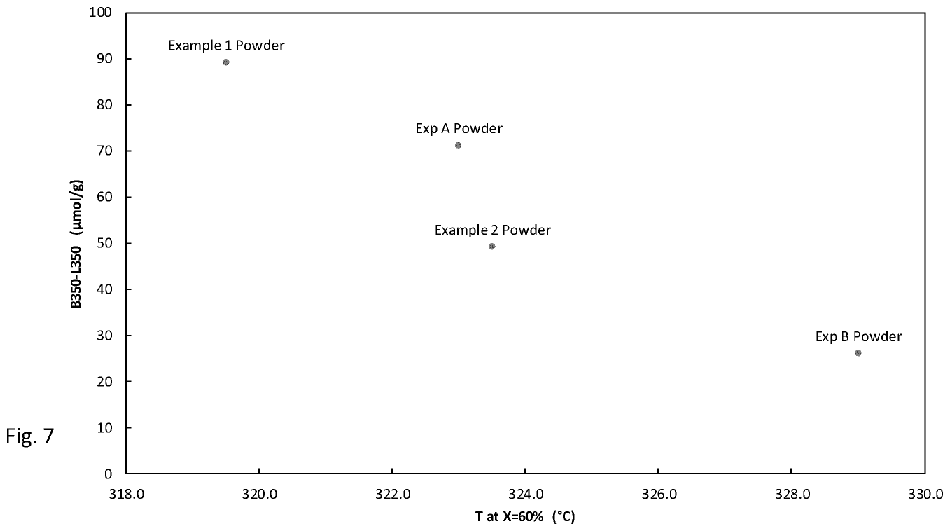

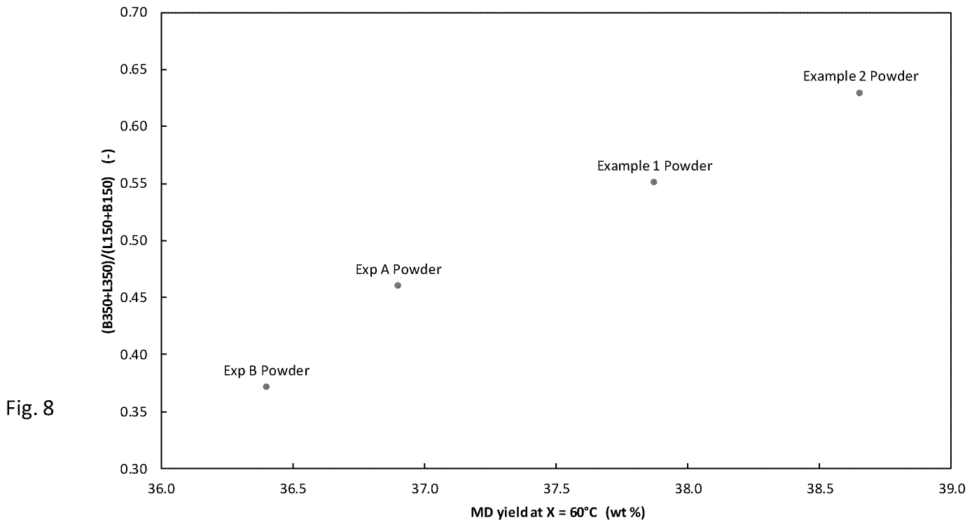

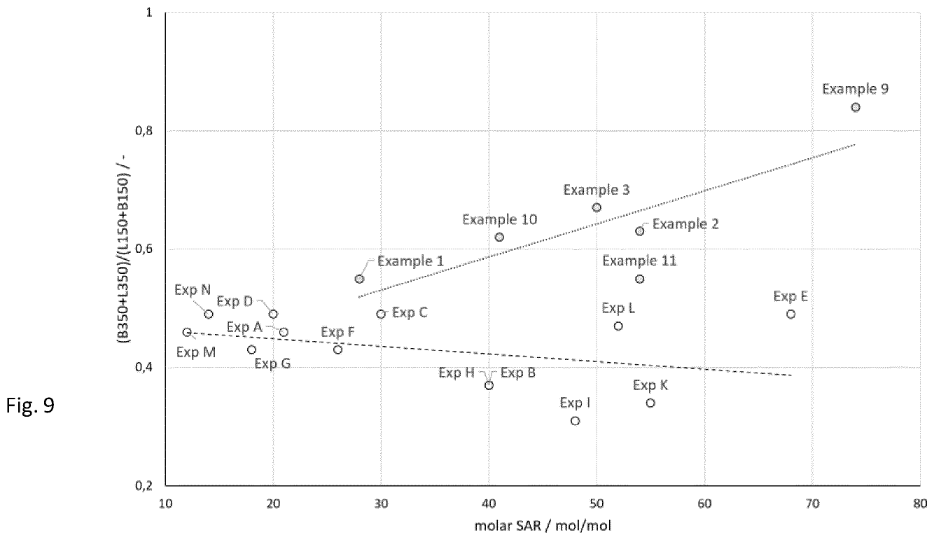

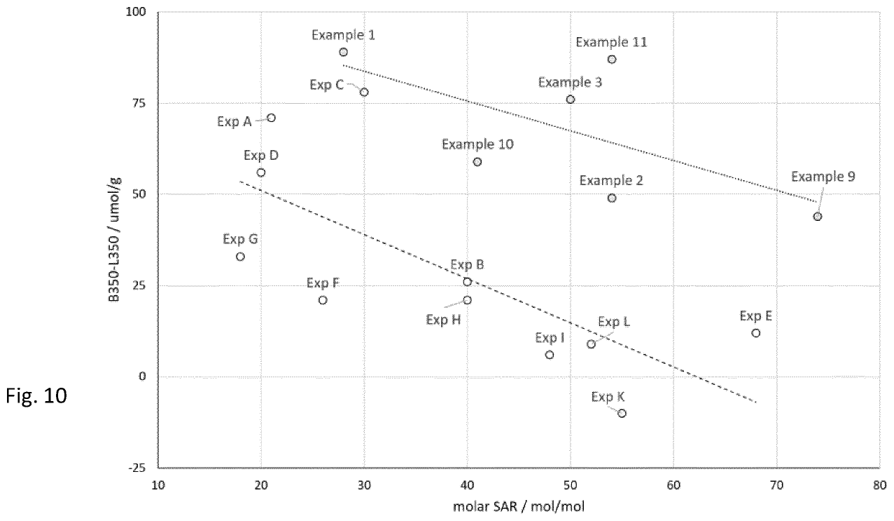

1. A compound of Zeolite-Y; the compound having a SiO₂/Al₂O₃ ratio of greater than 10 mol/mol as measured using X-ray fluorescence, a unit cell size smaller than 24.45 Å as measured by X-ray diffraction as described by the method of ASTM D3942-19, a micropore volume greater than 0.18 ml/g as described by the method of ASTM D4365-19, a mesopore volume greater than 0.35 ml/g as obtained by subtracting the micropore volume from the pore volume as obtained by the method of ASTM D4365-19, a total surface area greater than 600 m²/g as measured by the BET adsorption method of ASTM D4365-19 and a selectivity number greater than 0.50, wherein the selectivity number is presented as [(B350+L350)/(L150+B150)], wherein B350 is a Bronsted acidity of the zeolite-Y as measured by Fourier Transformed Infrared spectroscopy after pyridine desorption at 350° C., L350 is a Lewis acidity of the zeolite-Y as measured by Fourier Transformed Infrared spectroscopy after pyridine desorption at 350° C., B150 is a Bronsted acidity of the zeolite-Y as measured by Fourier Transformed Infrared spectroscopy after pyridine desorption at 150° C., and L150 is a Lewis acidity of the zeolite-Y as measured by Fourier Transformed Infrared spectroscopy after pyridine desorption at 150° C.

2. The compound of Zeolite-Y according to claim 1, wherein the SiO₂/Al₂O₃ ratio is greater than 20 mol/mol.

3. (canceled)

4. The compound of Zeolite-Y according to claim 1, wherein the selectivity number is greater than 0.55.

5. (canceled)

6. The compound of Zeolite-Y according to claim 1, wherein the zeolite-Y has an activity number greater than 40 μmol/g and smaller than 150 μmol/g, wherein the activity number is presented as B350-L350.

7. (canceled)

8. The compound of Zeolite-Y according to claim 1, wherein the pore volume of the zeolite Y is between 0.70 and 0.90 ml/g.

9. The compound of Zeolite-Y according to claim 1, wherein the mesopore volume of the zeolite Y is between 0.45 and 0.60 ml/g.

10. The compound of Zeolite-Y according to claim 1, wherein the total surface area of the zeolite Y is between 800 and 1000 m²/g.

11. The compound of Zeolite-Y according to claim 1, wherein the unit cell size of the zeolite Y is between 24.22 and 24.32 Å.

12. The compound of Zeolite-Y according to claim 1, obtainable by a mesoporization process wherein the selectivity number increases with respect to the starting parent zeolite-Y.

13. A method of preparing a modified zeolite-Y having a micropore volume greater than 0.18 ml/g as described by the method of ASTM D4365-19, a mesopore volume greater than 0.35 ml/g as obtained by subtracting the micropore volume from the pore volume as obtained by the method of ASTM D4365-19, a total surface area greater than 600 m²/g as measured by the BET adsorption method of ASTM D4365-19 starting from a starting zeolite Y, wherein the starting zeolite-Y has a SiO₂/Al₂O₃ ratio of greater than 15 mol/mol as measured using X-ray fluorescence, a unit cell size smaller than 24.40 Å as measured by X-ray diffraction as described by the method of ASTM D3942-19, a micropore volume greater than 0.18 ml/g, a mesopore volume smaller than 0.30 ml/g and a total surface area of between 500 and 1030 m²/g, the method comprising the following steps:
(a) gradually contacting a solid base or a base solution with the starting zeolite Y to obtain an intermediate alkaline-treated zeolite Y,
(b) contacting the intermediate alkaline-treated zeolite Y with an acid to obtain the modified zeolite Y and
(c) calcination at a temperature of at least 500° C. of the intermediate alkaline-treated zeolite Y obtained in step (a) prior to performing step (b) or calcination at a temperature of at least 500° C. of the modified zeolite Y obtained in step (b) as such or as shaped with a binder and wherein in step (a) a protective agent is present in the base solution and/or with the starting zeolite Y and wherein said protective agent comprises:
i) a quaternary ammonium cation, of which the longest carbon chain consists of at most 6 carbon atoms, and/or
ii) an alkylamine, of which the longest carbon chain consists of at most carbon 4 atoms.

14. The method of claim 13, wherein the protective agent in step (a) is an alkylamine, of which the longest carbon chain consists of at most carbon 4 atoms.

15. The method of claim 13, wherein the calcination in step (c) is performed on the modified zeolite Y obtained in step (b) as such.

16. The method of claim 13, wherein the gradually contacting of the solid base or of the base solution with the starting zeolite-Y is performed over a time period of at least 5 minutes and wherein over a period of one minute in that time period at most 50% of the total amount of base added in step (a) is contacted with the zeolite-Y.

17. (canceled)

18. The method of claim 13, wherein in step (a) the pH of the resulting reaction medium comprising the zeolite-Y and the base is in the range of 10 to 13.

19. The method of claim 13, wherein in step (b) the acid is gradually contacted with the alkaline-treated zeolite Y in a time period between 2 and 60 minutes, wherein the acid is added continuously or intermittently at a rate of below 3 mmol acid per gram zeolite Y per minute resulting in that in step (b) between are 0.1 to 10 mmol acid is added per gram alkaline-treated zeolite Y.

20. The method of claim 13, wherein in step (b) the pH of the resulting reaction medium comprising the zeolite-Y and added acid is in the range of 0 to 4.

21. The method of claim 13, wherein step (a) is batch wise executed on batches of at least 1 kg of starting zeolite-Y and step (b) is batch wise executed on batches of at least 1 kg of intermediate alkaline-treated zeolite Y.

22.-24. (canceled)

25. A method of hydrocracking, the method comprising use of the zeolite Y according to claim 1 as part of a hydrocracking catalyst composition.

26. A hydrocracking catalyst comprising a zeolite Y according to claim 1, a Group VIII metal, and a binder.

27.-29. (canceled)

30. A method of preparing middle distillates by contacting a hydrocarbonaceous feedstock boiling for more than 90 wt % above 360° C. under hydrocracking conditions with a catalyst according to claim 26 and wherein the feed conversion is above 40 wt % as expressed in the weight percentage of the fraction in the feedstock which boils above 360 degrees centigrade which are converted to products boiling below 360 degrees centigrade.
